(19) United States
(12) Patent Application Publication
(10) Pub. No.: US 2014/0356526 A1
(43) Pub. Date: Dec. 4, 2014

(54) COMPOSITION AND METHOD FOR ROADS, PARKING LOTS, AND DRIVING SURFACES

(71) Applicant: Invia Pavement Technologies, LLC, Tulsa, OK (US)

(72) Inventors: Timothy M. O'CONNELL, Tulsa, OK (US); Ronnie J. PRICE, Sapulpa, OK (US); David J. NORTHRUP, II, Mount Pleasant, SC (US); Andrew C. FOX, Tulsa, OK (US); Joseph LORENC, Philadelphia, PA (US); Andrew T. BICKFORD, Goose Creek, SC (US)

(21) Appl. No.: 14/285,750

(22) Filed: May 23, 2014

Related U.S. Application Data
(60) Provisional application No. 61/827,855, filed on May 28, 2013.

(51) Int. Cl. C09D 195/00; B05D 1/02

(52) U.S. Cl. CPC C09D 195/005; B05D 1/02
USPC 427/136; 524/60

(57) ABSTRACT

A method of producing a cationic asphalt slurry composition which can be used as an asphalt paving sealer or as a paving or repair composition. In the method and composition, latex and other polymers are used to build viscosity and a pH buffering filler is added to prevent flocculation. Consequently, the cationic composition can be stored without irreversibly settling or separating, and without breaking for several days prior to use. In addition, non-expansive clay and a polar polymer hardening agent are used so that, when applied, the composition will set and develop strength very quickly.

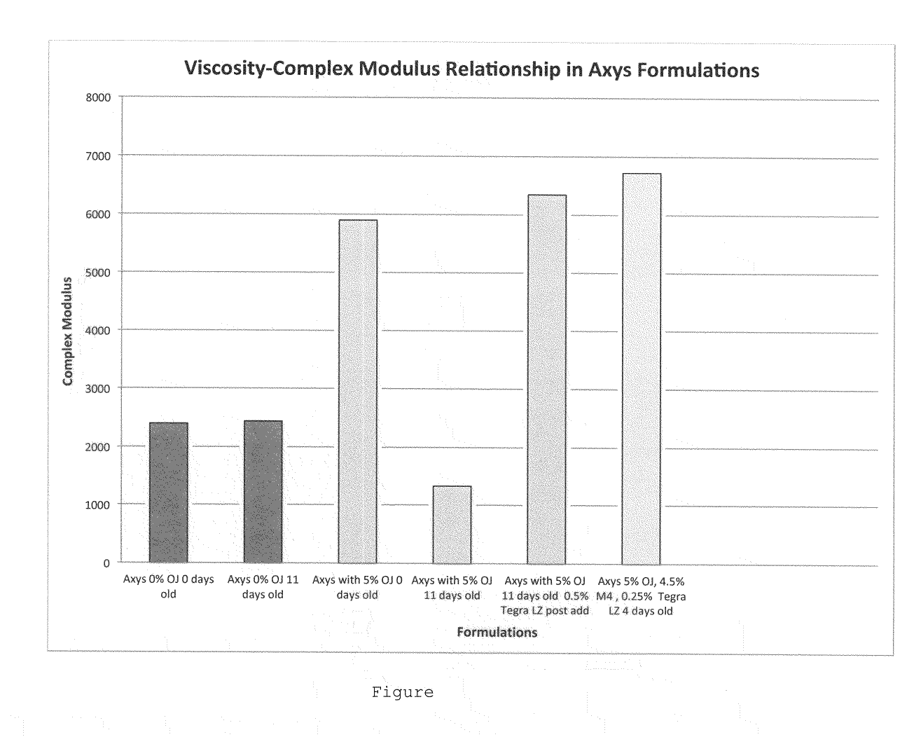

### CROSS REFERENCE TO RELATED APPLICATION

This application claims the benefit of U.S. Provisional Application No. 61/827855, filed May 28, 2013, and incorporates the same herein by reference in its entirety.

### FIELD OF THE INVENTION

The present invention relates to compositions and methods for sealing roads, parking lots, and other driving surfaces.

### BACKGROUND OF THE INVENTION

As is well known, asphalt paving can be used for constructing roads, parking lots, driveways, and pathways. After the asphalt paving has aged 3-5 years, a preventative maintenance treatment like a sealer will commonly be applied to the paving surface in order to (a) seal the surface from water intrusion (b) improve the appearance of the pavement, (c) protect the underlying asphalt pavement from oxidation and UV damage, (d) protect the pavement from oil and gasoline spills, and (e) provide a surface which is easier to sweep, clean, shovel, and maintain. All of these benefits increase the service life of the pavement,

Subsequently, a new coating of sealer material will preferably be applied to the asphalt pavement surface every two to three years or so. In addition, as cracks or other distressed areas appear in the paving surface, and particularly prior to applying a new coat of asphalt paving sealer, such distressed areas should be repaired by applying an asphalt filler material thereto.

Traditionally, the materials used for asphalt pavement crack repair and preventative maintenance have been liquid asphalt compositions. However, these liquid asphalt compositions are disadvantageous in that (1) they must be mixed with aggregate or other fillers at the application site, (2) they require many hours or days to adequately cure and dry, (3) traffic must be rerouted or slowed during the extended curing and drying time, (3) the resulting surface lacks sufficient skid resistance, (4) the material releases volatile organic compounds into the environment, and (5) the material can become sticky and track across the pavement and elsewhere in hot weather conditions, until the surface oxidizes sufficiently.

As an alternative to hot asphalt filling and sealing, another technique used for crack repair and surface sealing has been to apply an ambient asphalt emulsion. However, in addition to having many of the same problems and shortcomings as listed above for hot asphalt, the existing ambient asphalt emulsion compositions and techniques currently used in the art are generally known for their poor quality and lack of bonding to the existing pavement. The ambient emulsion materials used heretofore have been much too soft and, as with the hot pour materials, have generally lacked an aggregate framework. In addition, as compared to hot asphalt, any effort to add aggregate materials to ambient asphalt emulsions prior to use for road repair or sealing has been particularly problematic because the contact between the aggregate material and the asphalt emulsion causes the emulsion to break and begin to set.

Moreover, the ambient asphalt pavement sealers used heretofore to cover the entire surface of, e.g., a parking lot, a drive way, or a walking path have been particularly deficient in regard to scuffing, coating loss, stickiness, and tracking, especially on warm days following the application of the pavement sealer.

As is known in the art, ambient asphalt emulsion compositions are generally classified as anionic or cationic. The ambient asphalt emulsions heretofore used commercially in the art for pavement sealing and repair have generally been anionic compositions. Although, as discussed above, the properties and performance of these prior art anionic ambient asphalt emulsion repair and sealer compositions have been disappointing in all but the most temperate climates, the anionic ambient asphalt emulsion products are relatively stable and are relatively easy to prepare and use.

Cationic asphalt emulsions, on the other hand, typically have not been used in preparing commercial sealer or repair compositions, a primary reason being that the resulting cationic ambient asphalt emulsion compositions have heretofore been much less stable than anionic compositions. In fact, when forming a cationic emulsion slurry containing generally any amount of an aggregate material, the emulsion will typically break and set within as little as from 5 to 120 minutes once the asphalt emulsion and the aggregate material come into contact.

The inability in the art to effectively and realistically use cationic ambient emulsion compositions for pavement repair and sealing is illustrated, for example, in Patent Application Publication No. US 2006/0088379. US 2006/0088379 illustrates a prior art attempt to develop a system for preparing and applying a batch of a cationic ambient asphalt emulsion composition for filling ruts or depressions in a road surface. US 2006/0088379 attempts to accommodate the instability and other deficiencies of the prior art cationic ambient asphalt emulsion compositions to some degree by (1) adding a significant quantity of an extender (i.e., a reaction retarding agent) to the ambient asphalt emulsion composition to delay the setting process and (2) reducing the size of each batch so that the entire batch can be used up within minutes after it is produced.

Specifically, US 2006/0088379 discloses a trailer mounted unit which can be taken to the work site for blending batches of the ambient asphalt emulsion patching slurry. Once prepared, the finished batch of patching slurry is poured into the hopper of a spreader box vehicle and quickly taken to the repair site. Then, the vehicle must return to the blending trailer so that another small batch can be prepared and rapidly delivered. Moreover, as noted above, the batch of the prior art cationic ambient asphalt emulsion composition must also include a significant amount of a retarding agent.

Without the addition of the retarding agent, even when produced in such small batches, the spreader box vehicle would not be able to deliver the prior art cationic asphalt emulsion composition of US 2006/0088379 to the repair sites within the break time. Unfortunately, however, the addition of a retarding agent undesirably operates to (a) weaken the mastic properties of the asphalt material, (b) downgrade performance, (c) increase the water susceptibility of the material, and (d) decrease the life of the repair.

Consequently, a need exists for an improved ambient asphalt slurry composition and a method of preparing the composition wherein (a) the composition will provide significantly better properties and performance than the anionic and cationic compositions currently known in the art, (b) the composition can be premixed, transported and stored for several days, (c) the composition will withstand temperature changes and high temperature conditions during storage, and (d) the composition can be formulated and applied as an asphalt pavement sealer and can also preferably be alternatively adapted if desired for use as a repair composition or paving composition.

In addition, a need exists for a pre-mixed ambient asphalt emulsion sealer of this type which will allow two coats of the material to be spray applied (e.g., to an entire parking lot) and striped in a single day or overnight period, and then released to traffic. The ambient asphalt emulsion sealer will also preferably develop surface strength rapidly so that the surface will not be damaged by vehicles driving and turning on the surface. Further, the material will provide a tough, durable, tack-free (i.e., non-sticky) surface for vehicle and pedestrian traffic. In addition, the composition will preferably remain well-mixed (homogeneous) during storage and, when applied, provide good color, surface texture, and slip and skid resistance.

### SUMMARY OF THE INVENTION

The present invention provides cationic asphalt slurry compositions and a method of producing such compositions which surprisingly and unexpectedly satisfy the needs and alleviate the problems discussed above. The inventive method can be used to produce inventive cationic asphalt slurry compositions which are particularly well suited for application and use as asphalt pavement sealers. In addition, the inventive method can be used to produce similar inventive cationic asphalt slurry compositions which are adapted for use as asphalt repair or paving compositions.

The method of the present invention for producing a cationic asphalt slurry composition is preferably performed in a manner such that the viscosity of the slurry composition builds and is maintained throughout the blending process so that the components of the composition remain in suspension and a homogeneous mixture is produced which does not substantially and irreversibly settle or separate. In this regard, the inventive method operates to build and maintain the viscosity of the slurry suspension in a unique manner as a result of the interaction of the components of the inventive composition due to the nature of the components used and the order and manner in which they are added.

In addition, the inventive component formula preferably includes one or more pH buffering fillers, which will assist in preventing flocculation of the suspension, and subsequent loss of viscosity, during and after the blending process. The pH buffering filler(s) operate to (a) enable the system to better absorb sudden swings in pH which would occur as the components are added and as the components interact and/or chemically react with each other and (b) cause the pH of the inventive slurry composition product to equilibrate within a desired range which will render the cationic composition sufficiently stable for storage and transport.

In one aspect, there is provided a method of producing an asphalt slurry composition comprising the steps of: (a) adding a non-expansive clay to water to form an aqueous suspension; (b) adding a pH buffering filler to the aqueous suspension; (c) adding a latex polymer to the aqueous suspension; (d) after steps (b) and (c), adding a polar polymer hardening agent to the aqueous suspension; then (e) adding a cationic asphalt emulsion and to the aqueous suspension; and then (f) adding an aggregate material to the aqueous suspension. The pH buffering filler is added in step (b) in an amount sufficient to prevent flocculation of the aqueous suspension when the polar polymer hardening agent is present and the aggregate material is added in step (f). Also, the latex polymer added in step (c) is preferably a polymer which will operate to increase the viscosity of the aqueous suspension by reacting with an amine emulsifier contained in the cationic asphalt emulsion.

In addition, it is preferred that steps (a) through (f) be conducted in a manner, and that the pH buffering filler, the latex polymer, the polar polymer hardening agent, the cationic asphalt emulsion, and the aggregate material be added in amounts, such that the asphalt slurry composition produced by the method will remain in suspension without breaking for at least 14 days when stored in a closed container at a temperature of 50-125° F.

The method preferably also comprises the further step, following step (f), of (g) adding an associative thickener to the aqueous suspension which will react with the amine emulsifier in the cationic emulsion to further increase the viscosity of the asphalt slurry composition.

In another aspect, there is provided a method of producing an asphalt sealer slurry composition where the asphalt sealer composition produced by the method has a total final weight and the method comprises the steps of: (a) forming an aqueous suspension by adding a clay material selected from kaolinite clay, ball clay, or a combination thereof to water in an amount of from about 10% to about 22% by weight of the total final weight; (b) adding a pH buffering filler comprising calcium carbonate, magnesium carbonate, silica fume, calcined slate, calcined shale, alumina, or a combination thereof to the aqueous suspension in an amount of from about 1% to about 15% by weight of the total final weight; (c) adding a styrene acrylic polymer to the aqueous suspension in an amount of from about 2% to about 7% by weight of the total final weight; (d) after steps (b) and (c), adding polyvinyl alcohol to the aqueous suspension in an amount of from about 2% to about 10% by weight of the total final weight; then (e) adding a cationic asphalt emulsion to the aqueous suspension in an amount of from about 22% to about 33% by weight of the total final weight; and then (f) adding an aggregate material to the aqueous suspension in an amount of from about 9% to about 20% by weight of the total final weight.

In this method, the cationic asphalt emulsion includes an amine emulsifier which reacts with that the styrene acrylic polymer to increase the viscosity of the aqueous suspension. In addition, the amount of the pH buffering filler added in step (b) is an amount effective to prevent flocculation of the aqueous suspension when the polyvinyl alcohol is present. Further, the base asphalt used to produce the cationic asphalt emulsion preferably has a pen value of from about 20 to about 75. Also, substantially 100% of the aggregate material will preferably pass a number 8 US sieve.

It is also preferred that the method further comprise the step, following step (f), of (g) adding to the aqueous suspension an amount of at least 0.05% by weight, based on the total final weight, of an acrylic additive which reacts with the amine emulsifier to further increase the viscosity of the aqueous suspension. Further, the amount of the styrene acrylic polymer added in step (c) and the amount of the acrylic latex polymer added in step (g) will preferably together be effective such that the asphalt sealer slurry composition produced by the inventive method will have a final rotational viscosity at 20 rpm of from about 1000 to about 7000 centipoise.

In another aspect, there is also provided a method of sealing an asphalt pavement surface comprising steps of: (a) producing an asphalt sealer slurry composition using the method described above and (b) applying the asphalt sealer slurry composition to the surface of the asphalt pavement. The asphalt sealer slurry composition is preferably applied to the surface of the asphalt pavement by spraying.

Thus, in view of the above, it will be apparent to those in the art that the present invention provides cationic asphalt slurry compositions of a type which have heretofore been unknown. Moreover, the inventive composition and the inventive methods of producing and using the inventive composition run counter to the conventional wisdom in the art which teaches, for example, that to increase the viscosity of an asphalt emulsion, one should increase the solids content and/or include bentonite clay or similar additives which will hydrate and swell when mixed with water.

Consequently, the performance, characteristics, properties, benefits, and advantages provided by the inventive cationic asphalt slurry composition and by the inventive methods of producing and using the inventive composition are both surprising and unexpected. In contrast to the significant problems and deficiencies associated with the cationic compositions heretofore know in the art, the inventive cationic asphalt slurry product:
1. Will remain in suspension for storage and transport for up to 28 days or more even at temperatures below 45 and above 125° F.;
2. Gives up water more quickly than prior systems, thus resulting in faster set, dry, and cure times and rapid strength development;
3. Provides a strong, hard, and a durable product which is non-tacky and provides improved skid resistance;
4. Does not require and preferably does not include any reaction retarding agents or other additives which would detract from the properties of the product and delay the setting, curing, and hardening of the product after application;
5. Can be formulated to be applied using conventional sprayers, pavers, or other equipment; and
6. Can be applied as a sealer material in two coats and striped, if desired, in a single day or overnight period and then released to vehicle or pedestrian traffic.

Further aspects, features, and advantages of the present invention will be apparent to those of ordinary skill in the art upon examining the accompanying Drawing and upon reading the following Detailed Description of the Preferred Embodiments.

### BRIEF DESCRIPTION OF THE DRAWING

The drawing is a bar chart showing the results of the tests performed in accordance with the Example described herein.

### DETAILED DESCRIPTION OF THE PREFERRED EMBODIMENTS

The present invention provides cationic asphalt slurry compositions and methods of producing and using the inventive compositions. The inventive cationic asphalt slurry compositions are well suited for application and use as asphalt pavement sealers. In addition, the inventive method can be used to produce similar inventive cationic asphalt slurry compositions for use as asphalt repair or paving compositions.

In accordance with the steps of the inventive method, the following components are preferably added to water in the amounts, and also preferably in the order, listed. All amounts stated are in percentages by weight based on the total final weight of the cationic asphalt slurry composition produced by the inventive method:
1) Non-expansive clay (preferably from about 10% to about 22% by weight);
2) pH buffering filler (preferably from about 1% to about 15% by weight);
3) Colorant (preferably about 2% by weight);
4) Latex polymer (preferably from about 2% to about 7% by weight);
5) Polar polymer hardening agent (preferably from about 2% to about 10% by weight);
6) Cationic asphalt emulsion comprising an amine-based emulsifier (preferably from about 22% to about 33% by weight);
7) Aggregate (preferably from about 9% to about 20% by weight); and
8) Associative thickener (preferably from about 0.05 to about 1% by weight).

In the first step of the inventive process, the non-expansive clay is added to water. The total amount of water provided in forming the inventive cationic asphalt slurry composition will preferably be an amount in the range of from about 45% to about 55% by weight based on the total final weight of the asphalt slurry composition product. The non-expansive clay will preferably be added to the water and agitated over a period of from about 1 hour to about 4 hours with agitation to form an aqueous suspension.

The addition and agitation of the non-expansive clay and other components of the inventive composition will preferably be conducted in a mix tank with suitable agitation, such as e.g., a double helix ribbon blender. Alternatively, the non-expansive clay can be combined with the water under shear using, for example, a Cowle's mixer.

In contrast to bentonite clay and other materials which chemically combine with water to form hydrates, the non-expansive clay used in the inventive method and composition is a clay material which will not substantially hydrate and swell when mixed with water. As used herein and in the claims, the term “non-expansive clay” means that 50 grams of the clay added to 450 grams of water at 70° F., with no other additives, will produce a viscosity less than 500 cps as determined by rotational viscosity at 20 rpms with an RV4 spindle on a Brookfield viscometer.

The non-expansive clay will also preferably be effective such that, when added to water at the application ratios, the pH of the resulting suspension will preferably be in the range of from about 4 to about 9 and will more preferably be in the range of from about 4.2 to about 7. The pH of the clay suspension will most preferably be in the range of from about 4.5 to about 5.5.

The non-expansive clay will preferably be kaolinite clay, ball clay, or a combination thereof and will most preferably be kaolinite clay. In addition, the amount of non-expansive clay added in this step of the inventive process will most preferably be an amount of from about 13% to about 14% by weight base on the total final weight of the cationic asphalt slurry composition.

The pH buffering filler material added to the clay suspension in the next step of the inventive process can be one or more materials of a type, and will preferably be added in an amount, effective to (1) prevent flocculation and irreversible settling of the suspension system in storage and as each of the subsequent composition components is added in manufacturing and (2) cause the final cationic asphalt slurry product to equilibrate at a pH of from about 4 to about 9, more preferably from about 5 to about 8.5, and most preferably from about 6 to about 8.

Examples of suitable pH buffering fillers include, but are not limited to, calcium carbonate, magnesium carbonate, silica fume, calcined slate, calcined shale, alumina, and combinations thereof. The pH buffering filler will preferably be granulated calcium carbonate. In addition, the pH buffering filler will more preferably be added to the clay suspension in an amount of from about 2% to about 10%, most preferably from about 3% to about 5%, of the total final weight of the inventive cationic asphalt slurry product.

Examples of commercially available fillers with limited water solubility, suitable for use in the inventive method and composition include: Hubercarb M4 manufactured by JM Huber; Hubercarb Q4 manufactured by JM Huber; and Elkem EMS965 microsilica.

To provide a durable, visually appealing asphalt-like color which will also yield a high contrast background for striping, the colorant added to the clay suspension in the next step of the inventive procedure will preferably be carbon black. Although generally any effective amount can be used, the amount of carbon black added to the clay suspension will preferably be about 2% by weight of the total final weight of the inventive cationic asphalt slurry product. An example of a commercially available carbon black dispersion suitable for use in the inventive method and composition is Midnight Blak C manufactured by Solution Dispersions.

The latex polymer added to the clay slurry in the next step of the inventive method will preferably be an anionic latex polymer which will react with the amine-based emulsifier included in the subsequently added cationic asphalt emulsion to increase the viscosity of the aqueous suspension. The anionic latex polymer can have a fine particle size of up to 1 micron but preferably not more than 350 nanometers and will preferably be added in an amount such that the latex polymer, along with the associative thickener, if any, added later in the inventive method will cause the inventive cationic asphalt slurry product to equilibrate at a rotational viscosity (20 rpm) of from about 1000 to about 7000 centipoise, more preferably from about 2000 to about 5000 centipoise, and most preferably about 3000 centipoise. The anionic latex polymer will preferably be added in an amount of from about 2% to about 7% and will more preferably be added in an amount of from about 3% to about 5% by weight of the total final weight of the inventive cationic asphalt slurry product.

The anionic latex polymer is preferably a styrene acrylic polymer and most preferably has a glass transition temperature (Tg) of about 38° C. and a pH of about 8. Examples of styrene acrylic polymers preferred for use in the inventive method and composition include, but are not limited to Tegra GT available from Invia Pavement Technologies, LLC.

The anionic latex polymer also adds desirable thixotropic viscosity properties to the inventive cationic asphalt slurry product so that when it is exposed to high shear condition of a spray application nozzle the material discharges easily. However, the viscosity of the inventive composition will quickly rebuild so that the composition will not drip or run on the substrate to which it is applied.

The polar polymer hardening agent which is next added to the slurry suspension will preferably be polyvinyl alcohol or a similar additive which, when the inventive composition is applied and begins to dehydrate and cure, will cause the inventive composition to build superior strength very rapidly, even if a significant amount of water still remains in the composition. Through ionic interaction with the polar cites of the clay and with the anionic latex polymer, and also because of its desire to dehydrate and ability to cross-link with itself, the polyvinyl alcohol or other hardening agent operates to bind the composition together very quickly, following spray application, into a very strong 3 dimensional network. Moreover, the resulting structure is non-tacky and provides superior scuff resistance.

As noted above, the polar polymer hardening agent will preferably be added to the slurry suspension in an amount of from about 2% to about 10% and will more be added in an amount of about 5% by weight of the total final weight of the inventive cationic asphalt slurry product. Examples of commercially available polar polymer hardening agents include polyacrylic acid, polyacrylate and polyvinyl alcohol. The preferable material for use in the inventive method is: Tegra OJ polyvinyl alcohol available from Invia Pavement Technologies, LLC.

The cationic asphalt emulsion used in the inventive method and composition includes one or more amine-based emulsifiers and preferably has a pH of from about 2.1 to about 4.5. The cationic asphalt emulsion more preferably has a pH of from about 2.5 to about 3. In addition, particularly for use of the inventive composition as an asphalt pavement sealer, the penetration of the base asphalt of the cationic asphalt emulsion is such that the pen number will be in the range of from about 20 to about 75 and will more preferably be in the range of from about 30 to about 50.

Examples of amine-based emulsifiers suitable for use in the cationic emulsion for purposes of the present invention include, but are not limited to, diquaternary amine, lignin amine, tallow-diamine, tallow-diquaternary amine, amidoamine, tallow tetramine and imidazoline.

Examples of commercially available cationic asphalt emulsion compositions suitable for use in the inventive method and composition include: CSS-1HH manufactured by Invia Pavement Technologies, LLC and CSS-1HH manufactured by Vance Brothers, Inc.

The particle size of the aggregate material which is added in the next step of the inventive method, particularly when the inventive composition is intended for use as a spray-on pavement sealer, will preferably be such that 100%, or substantially 100%, of the aggregate material will pass a number 8 US sieve or, more preferably, a number 16 US sieve. The particle size of the aggregate material will also preferably be such that not more than 20% of the material will pass a number 200 US sieve.

An example of a commercially available aggregate material suitable for use in the inventive method and composition is Black Beauty XFine 30-60 manufactured by Harsco.

The associative thickener, which can be added at the end of the inventive method will preferably be an acrylic thickener which will also react with the amine-based emulsifier of the cationic asphalt emulsion to increase the viscosity of the cationic asphalt slurry product. The acrylic thickener is also preferably an alkali sensitive polymer that is cationic in composition.

An example of an acrylic thickener preferred for use in this step of the inventive method is Tegra LZ from Invia Pavement Technologies, LLC.

If used, the associative thickener will preferably be added to the slurry suspension in an amount of from about 0.05% to about 3%, more preferably from about 0.1% to about 1% and most preferably about 0.5%, of the total final weight of the inventive cationic asphalt slurry composition product. In addition, as mentioned above, the amount of the associative thickener added in combination with the amount of latex polymer added an earlier step of the inventive method will preferably be effective such that the inventive cationic asphalt slurry product will equilibrate at a rotational viscosity (20 rpm) of from about 1000 to about 7000 centipoise, more preferably from about 2000 to about 5000 centipoise, and most preferably about 3000 centipoise.

Contrary to the cationic asphalt slurry compositions heretofore produced in the art, particularly in the pH range of the inventive cationic asphalt slurry composition, the inventive composition can be stored, without breaking and setting, for up to 14 days, more preferably up to 28 days or more, in a closed container at a temperature of up to 125° F., and even at a temperature of up to 140° F. or more. In addition, the composition will remain in homogeneous suspension, without irreversible separation or settling, during storage and transport and without any significant loss of performance.

The cationic asphalt slurry product provided by the present invention can be applied using a conventional wand sprayer, a conventional sealer spray machine, or other conventional equipment. When applied, the inventive composition will cure as a result of dehydration and crosslinking and, as discussed above, will rapidly set and will quickly develop sufficient strength to be returned to vehicle or pedestrian traffic.

The following example is meant to illustrate, but in no way limit, the claimed invention.

### EXAMPLE

A cationic asphalt sealer composition was prepared by adding the following components to water in the amounts stated and in the order listed.

Example (A) & (B)

| | Percentage | |
|---|---|---|
| | by weight | |
| Component | composition | Manufacturer |
| Water | 38.19% | |
| Dunn B Clay | 20.2% | Old Hickory Clay |
| Hubercarb M4 | 0% | Huber Specialty Minerals |
| Midnite Blak Carbon | 2.25% | Specialty Dispersions |
| Black | | |
| Tegra GT | 5.6% | Invia Pavement Technologies |
| Tegra OJ | 0.0% | Invia Pavement Technologies |
| CSS-1HH | 33.7% | Invia Pavement Technologies |
| Black Beauty X Fine | 0% | Harsco Specialty Minerals |
| Tegra LZ | 0% | Invia Pavement Technologies |
| Biocide | .06% | Various |

When the material was only allowed to age 4 hours before testing began and then allowed to cure for 4 days (composition A), the complex modulus of the hardened sealer was 2300 kPa. When applied after 11 days of storage and allowed to cure for 17 hours (composition B), the complex modulus of the hardened sealer was substantially the same. The results are illustrated in the Drawing.

Next a sealer composition including a polar polymer hardening agent (polyvinyl alcohol) was prepared as follows:

Example (C) & (D)

| | Percentage | |
|---|---|---|
| | by weight | |
| Component | composition | Manufacturer |
| Water | 34.8% | |
| Dunn B Clay | 20.2% | Old Hickory Clay |
| Hubercarb M4 | 0 | Huber Specialty Minerals |
| Midnite Blak Carbon | 2.25% | Specialty Dispersions |
| Black | | |
| Tegra GT | 3.37% | Invia Pavement Technologies |
| Tegra OJ | 5.62% | Invia Pavement Technologies |
| CSS-1HH | 33.7% | Invia Pavement Technologies |
| Black Beauty X Fine | 0% | Harsco Specialty Minerals |
| Tegra LZ | 0% | Invia Pavement Technologies |
| Biocide | .06% | Various |

When applied within 4 hours and allowed to cure for 4 days (composition C), the complex modulus of the hardened sealer jumped to 5900 kPa. However, when the composition (composition D) was stored for 11 days the composition settled to a point that it could not be reversed simply by mixing or agitation, thereby loosing viscosity and, as a result, had a complex modulus of only 1300 kPa after curing for 17 hours. The results are also illustrated in the Drawing.

A composition E was prepared by treating composition D with 0.5% Tegra LZ. Upon addition, an immediate increase in the complex modulus of composition E was measured. (See the Drawing)

A further modified cationic asphalt sealer composition F including polyvinyl alcohol and also including a buffering filler (Hubercarb M4) was prepared as follows. In this case the measured complex modulus at 4 days age was 6730 kPa. (See the Drawing)

Example

| | Percentage | |
|---|---|---|
| | by weight | |
| Component | composition | Manufacturer |
| Water | 34.3% | |
| Dunn B Clay | 15.2% | Old Hickory Clay |
| Hubercarb M4 | 5.06% | Huber Specialty Minerals |
| Midnite Blak Carbon | 2.25% | Specialty Dispersions |
| Black | | |
| Tegra GT | 3.37% | Invia Pavement Technologies |
| Tegra OJ | 5.62% | Invia Pavement Technologies |
| CSS-1HH | 33.7% | Invia Pavement Technologies |
| Black Beauty X Fine | 0% | Harsco Specialty Minerals |
| Tegra LZ | .25% | Invia Pavement Technologies |
| Biocide | .25% | Various |

Thus, the present invention is well adapted to carry out the objects and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within this invention as defined by the claims.

What is claimed is:

1. A method of producing an asphalt slurry composition comprising the steps of:
(a) adding a non-expansive clay to water to form an aqueous suspension;
(b) adding a pH buffering filler to said aqueous suspension;
(c) adding a latex polymer to said aqueous suspension;
(d) after steps (b) and (c), adding a polar polymer hardening agent to said aqueous suspension; then
(e) adding a cationic asphalt emulsion to said aqueous suspension, said cationic asphalt emulsion including an amine emulsifier; and then
(f) adding an aggregate material to said aqueous suspension, wherein
said pH buffering filler is added in step (b) in an amount sufficient to prevent flocculation of said aqueous suspension when said polar polymer hardening agent is present and
said latex polymer is a polymer which will react with said amine emulsifier in said cationic asphalt emulsion to increase a viscosity of said aqueous suspension.

2. The method of claim 1 wherein said non-expansive clay is kaolinite clay, ball clay, or a combination thereof.

3. The method of claim 1 wherein said latex polymer is an anionic styrene acrylic polymer.

4. The method of claim 3 wherein said anionic styrene acrylic polymer has a particle size of less than 350 nanometers.

5. The method of claim 3 wherein said anionic styrene acrylic polymer is added to said aqueous suspension in step (c) in an amount sufficient that, in its final equilibrium form following step (f), said asphalt slurry composition will have a final rotational viscosity at 20 rpm of from about 1000 to about 7000 centipoise.

6. The method of claim 5 wherein said final rotational viscosity at 20 rpm will be from about 2000 to 5000 centipoise.

7. The method of claim 1 wherein said polar polymer hardening agent is polyvinyl alcohol, polyacrylic acid, or polyacrylate.

8. The method of claim 1 wherein said polar polymer hardening agent is polyvinyl alcohol.

9. The method of claim 1 wherein said pH buffering filler is calcium carbonate, magnesium carbonate, silica fume, calcined slate, calcined shale, alumina, or a combination thereof.

10. The method of claim 9 wherein said pH buffering filler is granulated calcium carbonate.

11. The method of claim 9 wherein said amount of said pH buffering filler added in step (b) is also effective such that said asphalt slurry composition, in its final equilibrium form following step (f), will have a final pH of from about 4 to about 9.

12. The method of claim 11 wherein said final pH of said asphalt slurry composition will be from about 6 to about 8.5.

13. The method of claim 1 wherein said cationic asphalt emulsion comprises a base asphalt having a pen value of from about 20 to about 75.

14. The method of claim 1 wherein said base asphalt of said cationic asphalt emulsion has a pen value of from about 30 to about 50.

15. The method of claim 1 wherein 100% of said aggregate material will pass a number 8 US sieve.

16. The method of claim 15 wherein not more that 20% of said aggregate material will pass a number 200 US sieve.

17. The method of claim 1 wherein:
said asphalt slurry composition has a final total weight
said non-expansive clay is added in step (a) in an amount of from about 10% to about 22% by weight of said final total weight,
said amount of said pH buffering filler added in step (b) is from about 1% to about 15% by weight of said final total weight,
said latex polymer is added in step (c) in an amount of at least 2% by weight of said final total weight,
said polar polymer hardening agent is added in step (d) in an amount of from about 2% to about 10% by weight of said final total weight,
said cationic asphalt emulsion is added in step (c) in an amount of from about 22% to about 33% by weight of said final total weight, and
said aggregate material is added in step (f) in an amount of from 9% to about 20% by weight of said final total weight.

18. The method of claim 1 further comprising the step, following step (f), of (g) adding an associative thickener to said aqueous suspension which will react with said amine emulsifier in said cationic asphalt emulsion to increase said viscosity of said asphalt slurry composition.

19. The method of claim 18 wherein said associative thickener is an alkali sensitive acrylic thickener.

20. The method of claim 19 wherein:
said latex polymer added in step (c) is a styrene acrylic polymer, said styrene acrylic polymer is added in step (c) in an amount of at least 2% by weight of a final total weight of said asphalt slurry composition,
said associative thickener is added in step (g) in an amount of at least 0.05% by weight of said final total weight of said asphalt slurry composition, and
said amount of said styrene acrylic polymer added in step (c) and said amount of said associative thickener added in step (g) are together effective such that said asphalt slurry composition, in its final equilibrium form following step (g), will have a final rotational viscosity at 20 rpm of from about 1000 to about 7000 centipoise.

21. The method of claim 20 wherein said final rotational viscosity at 20 rpm will be from about 2000 to about 5000 centipoise.

22. The method of claim 1 wherein steps (a) through (f) are conducted in a manner and said non-expansive clay, said pH buffering filler, said latex polymer, said polar polymer hardening agent, said cationic asphalt emulsion, and said aggregate material are added in amounts such that said asphalt slurry composition produced by said method can be stored without breaking for at least 14 days in a closed container at a temperature of 125° F.

23. An asphalt slurry composition produced by the method of claim 1.

24. An asphalt slurry composition produced by the method of claim 2.

25. An asphalt slurry composition produced by the method of claim 5.

26. An asphalt slurry composition produced by the method of claim 7.

27. An asphalt slurry composition produced by the method of claim 9.

28. An asphalt slurry composition produced by the method of claim 11.

29. An asphalt slurry composition produced by the method of claim 12.

30. An asphalt slurry composition produced by the method of claim 13.

31. An asphalt slurry composition produced by the method of claim 15.

32. An asphalt slurry composition produced by the method of claim 17.

33. An asphalt slurry composition produced by the method of claim 20.

34. An asphalt slurry composition produced by the method of claim 22.

35. A method of producing an asphalt slurry sealer composition wherein said asphalt slurry sealer composition produced by said method has a total final weight and said method comprises the steps of:
(a) forming an aqueous suspension by adding a clay material selected from kaolinite clay, ball clay, or a combination thereof to water in an amount of from about 10% to about 22% by weight of said total final weight;
(b) adding a pH buffering filler comprising calcium carbonate, magnesium carbonate, silica fume, calcined slate, calcined shale, alumina or a combination thereof to said aqueous suspension in an amount of from about 1% to about 15% by weight of said total final weight;
(c) adding styrene acrylic polymer to said aqueous suspension in an amount of from about 2% to about 7% by weight of said total final weight;
(d) after steps (b) and (c), adding polyvinyl alcohol to said aqueous suspension in an amount of from about 2% to about 10% by weight of said total final weight; then
(e) adding a cationic asphalt emulsion to said aqueous suspension in an amount of from about 22% to about 33% by weight of said total final weight; and then
(f) adding an aggregate material to said aqueous suspension in an amount of from about 9% to about 20% by weight of said total final weight, wherein
said cationic asphalt emulsion includes an amine emulsifier which reacts with said styrene acrylic polymer to increase a viscosity of said aqueous suspension,
said cationic asphalt emulsion comprises a base asphalt having a pen value from about 20 to about 75, and
substantially 100% of said aggregate material will pass a number 8 US sieve.

36. The method of claim 35 further comprising the step, following step (f), of (g) adding to said aqueous suspension an amount of at least 0.05% by weight of said total final weight of an acrylic additive which reacts with said amine emulsifier to further increase said viscosity of said aqueous suspension, wherein said amount of said styrene acrylic polymer added in step (c) and said amount of said acrylic additive added in step (g) are together effective such that said asphalt sealer slurry composition produced by said method will have a final rotational viscosity at 20 rpm of from about 1000 to about 7000 centipoise.

37. The method of claim 36 wherein said final rotational viscosity at 20 rpm will be from about 2000 to about 5000 centipoise.

38. The method of claim 35 wherein steps (a) through (f) are conducted in a manner and said amounts of said clay material, said pH buffering filler, said styrene acrylic polymer, said polyvinyl alcohol, said cationic asphalt emulsion, and said aggregate material are effective such that said asphalt sealer slurry composition produced by said method can be stored without breaking for at least 14 days in a closed container at a temperature of 125° F.

39. An asphalt slurry sealer composition produced by the method of claim 35.

40. An asphalt slurry sealer composition produced by the method of claim 36.

41. An asphalt slurry sealer composition produced by the method of claim 37.

42. An asphalt slurry sealer composition produced by the method of claim 38.

43. A method of applying an asphalt sealer to an asphalt pavement comprising the steps of
(a) producing an asphalt sealer slurry composition using the method of claim 35 and
(b) applying said asphalt sealer slurry composition to a surface of said asphalt pavement.

44. The method of claim 43 wherein said asphalt sealer slurry composition is applied to said surface of said asphalt pavement by spraying.

45. A method of applying an asphalt sealer to an asphalt pavement comprising the steps of:
(a) producing an asphalt sealer slurry composition using the method of claim 36 and
(b) applying said asphalt sealer slurry composition to a surface of said asphalt pavement.

46. The method of claim 45 wherein said asphalt sealer slurry composition is applied to said surface of said asphalt pavement by spraying.
